(19) United States
(12) Patent Application Publication
(10) Pub. No.: US 2026/0008961 A1
(43) Pub. Date: Jan. 8, 2026

(54) METHOD FOR THE PRODUCTION OF A PYROLYSIS OIL FROM END-OF-LIFE PLASTICS

(71) Applicant: Plastic Energy Limited, London London (GB)

(72) Inventor: Pierre MOREAU, Abingdon (GB)

(21) Appl. No.: 19/323,836

(22) Filed: Sep. 9, 2025

Related U.S. Application Data
(63) Continuation of application No. PCT/EP2024/056160, filed on Mar. 8, 2024.

(30) Foreign Application Priority Data
Mar. 9, 2023 (GB) 2303478.8

(51) Int. Cl. C10G 1/10; B01J 29/40; B01J 35/63; B01J 35/77

(52) U.S. Cl. CPC C10G 1/10; B01J 29/40; B01J 35/633; B01J 35/77; C10G 2300/1003; C10G 2300/706

(57) ABSTRACT

There is provided a method for the production of a pyrolysis oil from end-of-life plastics, the method comprising: (i) providing end-of-life plastics material; (ii) melting the end-of-life plastics material to form a molten plastics material; (iii) pyrolysing the molten plastics material in an oxygen-free atmosphere to provide pyrolysis gases and a char material; (iv) condensing the pyrolysis gases to provide the pyrolysis oil; wherein the method further comprises dispersing a zeolitic material in the end-of-life plastics material or in the molten plastics material, characterised in that the zeolitic material comprises a zeolite having a molar silica to alumina ratio (SAR) of from 10 to 140, a mean crystal size of about 200 nm or less, and wherein the zeolitic material has a mesopore volume of at least 0.30 cm3/g and a micropore volume of at least 0.10 cm3/g.

### CROSS-REFERENCE TO RELATED APPLICATION(S)

This application is a continuation of International Patent Application No. PCT/EP2024/056160, filed Mar. 8, 2024, which claims priority to Great Britain Patent Application No. 2303478.8, filed Mar. 9, 2023, which is hereby incorporated by reference in its entirety.

### DETAILED DESCRIPTION

The present disclosure relates to a method for the production of a pyrolysis oil from end-of-life plastics, in particular to a method comprising dispersing a zeolitic material in the end-of-life plastics before pyrolysis and condensing the pyrolysis gases to provide the pyrolysis oil. In particular, the method incorporates a catalytic zeolite material which improves the quality of the final product and can itself be reused for further treatments. In particular, the method identifies a catalyst which appears to be unaffected by the presence of impurities in the end-of-life plastics and this provides a significant improvement without adding to the process complexity.

Mesoporous zeolites are a class of zeolites with high mesopore volumes (in contrast to conventional zeolites with low or absent mesoporosity) that are well known for their improved diffusion properties. The faster diffusion within mesopores provides better access of reactants to the catalytic sites in the zeolite micropores and can result in an improved catalytic performance of such materials.

Increased mesoporosity in a zeolite can be achieved by a variety of methods. One method is using mesoporogens during the zeolite synthesis. Mesoporogens are typically organic compounds that form and fill mesopores during the zeolite synthesis. Another method is synthesis of nanosized zeolites, which have short diffusion distances within individual crystals and possess intercrystalline mesoporosity. Yet another method is selective removal of a part of the zeolite framework, wherein the formed voids are within the mesopore size range. Selective removal of the zeolite framework is typically done by the process of zeolite desilication with a suitable base. A part of the zeolite framework is dissolved during the desilication process and represents a loss of material, which can result in an increase of the production costs.

ZSM-5 zeolite (MFI framework, as defined by the IZA) is used in industry for many petrochemical applications. A ZSM-5 zeolite can be synthesized with or without organic structural direction agent (OSDA) such as tetrapropylammonium bromide. A ZSM-5 zeolite with improved mesoporosity produced with a minimal loss during the desilication can be an advantageous material for such applications.

End-of-life plastic chemical recycling is an emerging technology designed to recycle mixed waste-plastics into a variety of liquid hydrocarbon products. The waste plastics for use in such a process may, for example, include low density polyethylene (LDPE), high density polyethylene (HDPE), polystyrene (PS), and/or polypropylene (PP).

Plastic waste is currently a major problem in the world and is causing a significant number of environmental issues. Pyrolysis of waste plastics is commonly accepted as a highly promising solution for this problem.

Pyrolysis treatments are known for converting these waste plastics into the liquid hydrocarbon products by heating and then pumping the plastic feed in molten form into reactor vessels. The reactor vessels are heated by combustion systems to a temperature in excess of 350° C. This produces rich saturated hydrocarbon vapour from the molten plastic. This flows out of the reactor vessels through contactor vessels and will condense the heavier vapour fractions to maintain a target outlet temperature set point which is determined by the end-product specification. This is then distilled at near-atmospheric pressures in a downstream condensing column. This process obtains a so-called pyrolysis oil.

WO2021123822 (as well as GB2589936) discloses a method for pyrolysing plastic material. The method comprises the steps of: heating and densifying plastic material; transporting the plastic material to one or more reactors; and pyrolysing the plastic material in the one or more reactors. The plastic material is maintained in a heated state during the transporting step.

WO2016030460 discloses a pyrolysis reactor system suitable for the treatment of end-of-life plastics.

WO2011077419 also discloses a process for treating waste plastics material to provide at least one on-specification fuel product. Plastics material is melted (4) and then pyrolysed in an oxygen-free atmosphere to provide pyrolysis gases. The pyrolysis gases are brought into contact with plates (13) in a contactor vessel (7) so that some long chain gas components condense and return to be further pyrolysed to achieve thermal degradation. Short chain gas components exit the contactor in gaseous form; and proceed to distillation to provide one or more on-specification fuel products. There is a pipe (12) directly linking the pyrolysis chamber (6) to the contactor (7), suitable for conveying upwardly-moving pyrolysis gases and downwardly-flowing long-chain liquid for thermal degradation. There is a vacuum distillation tower (26) for further processing of liquid feeds from the first (atmospheric) distillation column (20). It has been found that having thermal degradation in the contactor and pyrolysis chamber and by having a second, vacuum, distillation column helps to provide a particularly good quality on-specification liquid fuel.

By pyrolysing plastic, it is broken down into a hydrocarbon rich oil. This oil can then be used to produce monomeric species via the refining process. Once in the monomeric state, the molecules can then be polymerised to form virgin grade plastic. This effectively closes the loop on the plastic production process, reducing waste and environmental impact. In addition, all of these foregoing methods and processes are suitable for obtaining a pyrolysis oil which can be used as a fuel, especially for transportation purposes.

U.S. Pat. No. 5,107,061 is directed to the removal of organochlorides from hydrocarbon streams using highly crystalline molecular sieve material, such as zeolites, and particularly zeolite X in a sodium form, and the removal of organochlorides from hydrocarbon streams containing olefinic compounds using such molecular sieves in combination with alumina for the purpose of effecting a decomposition of the organochloride into a corresponding unsaturated hydrocarbon molecule and a molecule of hydrocarbon chloride, wherein the hydrocarbon chloride is removed from the hydrocarbon stream by being adsorbed onto the adsorbent of the highly crystalline molecular sieve so that the unsaturated hydrocarbon molecule may be recovered from the resultant hydrocarbon stream containing a reduced amount of organochlorides.

U.S. Pat. No. 4,721,824 relates to a method for removing trace amounts of organic chlorides from feedstocks by passing the feedstock in contact with a guard bed catalyst comprising shaped particles formed by extruding a mixture of magnesium oxide and a binder inert to the feedstock. The process has particular importance in removing organic chlorides from toluene feedstocks prior to contacting toluene with a disproportionation or alkylation catalyst comprising magnesium-ZSM-5.

U.S. Pat. No. 3,862,900 relates to a method for treating hydrocarbons containing chemically combined chlorine by passing the hydrocarbons through a bed of molecular sieves of effective pore size in the range of 7 to 11 Angstrom units to remove the chemically combined chlorine and other impurities.

EP1728551 relates to desulfurization of gasoline cut by adsorption on a faujasite zeolite. This has a silicon/aluminium molar ratio of 1-10, a meso and macroporosity volume of 0.25-0.4 cm3/g, a microporosity volume of 0.12-0.35 cm3/g and a size of crystals less than 3 microns.

“Influence of mesoporous structure ZSM-5 zeolite on the degradation of Urban plastics waste” Journal of Thermal Analysis and calorimetry, 2019, 138, 3689-3699 relates to mesoporous ZSM-5 zeolite structures as pyrolysis catalysts.

“Catalytic Cracking of a Polyolefin Mixture over Different Acid Solid Catalysts” Ind. Eng. Chem. Res. 2000, 39, 5, 1177-1184 relates to use of zeolite with nanometer crystal size in catalytic cracking of a polyolefin mixture.

EP3907267 relates to a process for purifying a crude pyrolysis oil originating from the pyrolysis of plastic waste by subjecting a crude pyrolysis oil with a trapping agent, wherein the trapping agent is selected from a wide list which includes elemental metals of groups 1, 2, 6, 7, 8, 9, 10, 11, 12 and/or 13, oxides of said metals, an alkoxide of metals of groups 1 and/or 2, and solid sorption agents.

WO2018025104 relates to simultaneous pyrolysis and dechlorination of mixed plastics comprising contacting the mixed plastics with a zeolitic catalyst in a pyrolysis unit.

WO2018025103 relates to the treatment of hydrocarbon streams via processes which include dechlorination, the processes comprising introducing a hydrocarbon stream and/or hydrocarbon stream precursor, a first zeolitic catalyst, and a stripping gas to a devolatilization extruder (DE) to produce an extruder effluent.

KR1020190002793 relates to the co-catalytic co-pyrolysis of an e-PCB (e-printed circuit board) and plastic using zeolite, and specifically, an epoxy printed electronic circuit using HZSM-5 or HY zeolite catalyst, preferably the large pore zeolite. Examples of e-PCB use FR-4 which is a known composite material composed of woven fiberglass cloth with an epoxy resin binder.

CN102039155 relates to a catalyst for catalytic upgrading of waste plastic cracking oil and a preparation method thereof and discloses a modified HZSM molecular sieve for catalytic reformation of a pyrolysis oil.

GB2613166 provides a method for the removal of impurities from a pyrolysis oil obtained from end-of-life plastics, the method comprising: contacting the pyrolysis oil with an absorbent selected from the group consisting of a large pore zeolite, activated alumina and a mixture thereof, to obtain a purified pyrolysis oil.

EP1728551 describes the application of caesium-exchanged X, Y or LSX type faujasite zeolites for intense desulphurization of FCC gasoline, and to a method for preparing said zeolites.

WO2020056838 relates to a molecular sieve with a hierarchical pore FAU structure, a preparation method therefor and a modified molecular sieve with a hierarchical pore FAU structure, belonging to the fields of molecular sieve modification, adsorption material preparation and catalyst preparation.

Accordingly, it is also an object of the present invention to provide a method for the production of a pyrolysis oil from end-of-life plastics with reduced impurities and/or requiring less post-production refinement. One problem with zeolite ZSM-5 is that it is known to increase the yield to gas, at the expense of distillate yield. Thus, it is a further object to increase the yield to distillate or at least to tackle problems associated with the prior art, or provide a commercially viable alternative thereto.

In a first aspect of the present invention, there is provided a method for the production of a pyrolysis oil from end-of-life plastics, the method comprising:
(i) providing end-of-life plastics material;
(ii) melting the end-of-life plastics material to form a molten plastics material;
(iii) pyrolysing the molten plastics material in an oxygen-free atmosphere to provide pyrolysis gases and a char material;
(iv) condensing the pyrolysis gases to provide the pyrolysis oil;
wherein the method further comprises dispersing a zeolitic material in the end-of-life plastics material or in the molten plastics material, characterised in that the zeolitic material comprises a zeolite having a molar silica to alumina ratio (SAR) of from 10 to 140, a mean crystal size of about 200 nm or less, and wherein the zeolitic material has a mesopore volume of at least 0.30 cm3/g and a micropore volume of at least 0.10 cm3/g.

The present disclosure will now be described further. In the following passages, different aspects/embodiments of the disclosure are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

### Definitions

“Micropore volume” or “Vmicro” is used to indicate the total volume of pores having a diameter of less than 20 Angstroms. “Initial Micropore Volume” means the micropore volume of the freshly made crystalline material before exposing it to any desilication conditions. The assessment of micropore volume is particularly derived from the BET measurement techniques by an evaluation method called the t-plot method (or sometimes just termed the t-method) as described in the literature (Journal of Catalysis 3,32 (1964)).

Herein “mesopore volume” or “mesoporosity” or “Vmeso” is the volume of pores having a diameter of greater than 20 Angstroms up to the limit of 600 Angstroms, as determined by applying BJH method to the desorption branch of N2 isotherm.

Herein, a “parent zeolite” or “parent material” refers to the initial zeolite material that is for desilicating before it is exposed to any desilication conditions.

“Defined by the Structure Commission of the International Zeolite Association (IZA)” is intended to mean those structures included but not limited to, the structures described in “Atlas of Zeolite Framework Types,” ed. Baerlocher et al. Sixth Revised Edition (Elsevier 2007), which is herein incorporated by reference in its entirety.

Silica loss is calculated as follows: silica loss=1−SARd/SARp, where SARd is the SAR of the alkali-form or ammonium-form after desilication, SARp is the SAR of the parent non-desilicated zeolite, and expressed as percentage.

ΔV is calculated between the difference in the mesopore volume of the ammonium-exchanged desilicated zeolite and the mesopore volume of the ammonium-exchanged non-desilicated zeolite (parent material), and expressed in cc/g.

ΔV/silica loss is calculated as the ratio of ΔV to the silica loss and represents the increase of mesopore volume per percentage of silica loss.

“Mean crystal size” is the average size of zeolite crystals along the longest crystal dimension averaged over randomly selected 100 crystals from SEM micrographs.

In order to address the aforementioned problems relating to plastic pyrolysis, the inventors have found that a desilicated small crystal zeolite is an unexpectedly effective additive, and the present invention relates to a method for the production of a pyrolysis oil from end-of-life plastics comprising use of such a zeolite.

The method comprises the general steps of:
(i) providing end-of-life plastics material;
(ii) melting the end-of-life plastics material to form a molten plastics material;
(iii) pyrolysing the molten plastics material in an oxygen-free atmosphere to provide pyrolysis gases and a char material;
(iv) condensing the pyrolysis gases to provide the pyrolysis oil.

Such steps are known in the art whereby steps (i)-(iv) provide the steps necessary for plastics pyrolysis and recovery of the distillate as a pyrolysis oil. The method crucially further comprises dispersing a zeolitic material in the end-of-life plastics material or in the molten plastics material, i.e. prior to pyrolysis. Accordingly, step (iii) of pyrolysing the molten plastics material takes place in the presence of the zeolite (i.e. involves pyrolysing the mixture of molten plastics material and zeolitic material).

The present inventors have found that there are particular issues with the use of pyrolysis oils obtained from pyrolysis of end-of-life plastics when seeking to use the pyrolysis oil as a feedstock for a cracking process, or even when using the oil as a transportation fuel. In particular, compared to natural oil materials, the pyrolysis oil obtained from end-of-life plastics has unacceptably high levels of mercury and phosphorous, as well as the typical sulphur and chlorine contaminants. Without wishing to be bound by theory, it is considered that the level of these impurities is a direct result of contaminants mixed with the plastics from their original lifetime use.

The method firstly requires providing end-of-life plastics material. End-of-life or contaminated plastic waste feedstock, for plastic chemical recycling, may be received from, for example, municipal recovery facilities, recycling factories, or other plastic collection sources. During a pre-treatment process, the feedstock may be refined such that it only contains plastics suitable for the chemical recycling process, such as low density polyethylene (LDPE), high density polyethylene (HDPE), polystyrene (PS), and/or polypropylene (PP). Unsuitable materials, such as metals, paper and card, and glass (including fibreglass), as well as humidity from the plastic waste, may be removed. As such, it is preferred that the plastics material comprises at least 90 wt % plastic (e.g. organic polymer) by weight of the plastics material, and especially preferred that the plastics material consists essentially of plastic. In particular, it is preferred that the plastics material is free from metal contaminants.

The end-of-life plastics material may be obtained from a common source or from mixed sources, including mixed plastic waste obtained from municipal or regional sources and/or from waste streams of polyethylene terephthalates (PET), high density polyethylene (HDPE), low density polyethylene (LDPE), linear low density polyethylene (LLDPE), polypropylene, and/or polystyrene. Furthermore, the waste may include thermoplastic elastomers and thermoset rubbers, such as from tires and other articles made from natural rubber, polybutadiene, styrene-butadiene, butyl rubber and ethylene propylene diene monomer rubber (EPDM). The waste may include one or more plastics classified as plastic identification code (PIC) 1 to 7 by the Society of the Plastics Industry. For example, the waste may include one or more of the following plastics: polyethylene terephthalate classified as PIC 1; high-density polyethylene classified as PIC 2; polyvinyl chloride classified as PIC 3; low-density polyethylene classified as PIC 4; polypropylene classified as PIC 5; polystyrene classified as PIC 6; and polycarbonate and other plastics classified as PIC 7. In some embodiments, it is preferred that the plastic is hydrocarbon plastic (which is plastic which consists essentially of carbon and hydrogen, such as PE, PP and PS). For example, the plastics material comprises a majority of hydrocarbon plastic, preferably at least 80 wt %, or at least 90 wt % by weight of the plastic material, or may consist essentially of hydrocarbon plastic. In some embodiments, the plastics material is substantially free of halogenated plastics such as PVC. It is preferred that the plastics material is free from metal contaminants.

A pyrolysis oil may be obtained by the thermal treatment of these plastics materials. WO2021123822 discloses an optimised process for this pyrolysis and the contents of this document are incorporated herein in their entirety by reference. This sort of pyrolysis oil, because of its source, typically contains a number of impurities, including: Sulphur; Chlorine; Phosphorus; Metals: especially mercury, but also arsenic, lead, nickel and the like; Silica; Oxygen and Nitrogen. As will be appreciated, the elements, in particular the metals, may be present in their elemental form though will typically be present as compounds such as salts and/or organic impurities comprising said elements (i.e. organosulphur impurities and so forth).

The method comprises melting the end-of-life plastics material to form a molten plastics material. Preferably the end-of-life plastics material is melted in step (ii) in a heated extruder at a temperature of from 250 to 350° C.

The method comprises pyrolysing the molten plastics material in an oxygen-free atmosphere to provide pyrolysis gases and a char material. Preferably the pyrolysis of step (iii) is conducted in an optionally agitated pyrolysis reactor at a temperature of from 350 to 450° C.

The method comprises condensing the pyrolysis gases to provide the pyrolysis oil. Preferably step (iv) comprises distilling said pyrolysis gases from the contactor in a distillation column.

Preferably before step (iv), the method further comprises:
passing the pyrolysis gases from step (iii) into a contactor having a bank of condenser elements so that some long chain gas components condense on said elements to provide a condensed long chain material;
returning said condensed long chain material to step (iii) to be further pyrolysed; and
allowing short chain gas components to exit from the contactor in gaseous form before condensing in step (iv).

Critically, the method further comprises dispersing a zeolitic material as described herein in the end-of-life plastics material or in the molten plastics material. The present inventors have surprisingly found that the addition of such a zeolitic material into the Plastic Energy process can catalyse the pyrolysis step, leading to a higher yield of a lighter oil. It is particularly surprising that the zeolitic material can be added with the raw feed material, rather than needing to be added into the pyrolysis chamber. The zeolitic material appears to be unaffected by the presence of impurities in the end-of-life plastics and this provides a significant improvement without adding to the process complexity.

Zeolites are well known for use in various industrial treatment processes and are commonly categorised by their pore sizes. In particular, there is a focus on the number of atoms which form their largest ring size, since this is a practical limitation on the ease with which molecules can diffuse into and out of the zeolite during a process. A small pore zeolite has a ring of 8 atoms, whereas a medium pore zeolite has a ring of 10 atoms and a large pore zeolite has a ring of 12 atoms. The zeolite used is preferably an aluminosilicate zeolite, having a framework consisting of Al and Si atoms. A further characteristic of zeolites is the form in which they are supplied, such as the Na+ or H+ form. In addition, the zeolites can be substituted with additional metal species, especially for catalytic purposes, such as the introduction of copper for SCR catalysts. In the present invention the zeolite is preferably free from such added catalytic metals.

Preferably the zeolitic material comprises a medium pore zeolite. The optimised zeolite for use in the present method is a zeolite having the MFI framework type, most preferably ZSM-5. The inventors have surprisingly discovered that selecting a zeolite with MFI framework having specific parameters can be advantageously used to desilicate such material at a higher efficiency (higher ΔV/silica loss) than a conventional commercial zeolite with MFI framework. The inventors have also surprisingly discovered that the presence of an OSDA in the parent zeolite can be advantageously used to desilicate such material at an even higher efficiently (higher ΔV/silica loss) than a conventional commercial zeolite with MFI framework or zeolite with MFI framework in calcined OSDA-free form. Preferably the zeolite is used in the H-exchanged form for catalysing the pyrolysis reaction. Preferably the zeolite is free from any added metals. That is, preferably the zeolite consists of Al2O3 and SiO2 (i.e. an aluminosilicate), and when in the Na exchanged form Na2O (i.e. a sodium aluminosilicate).

Preferably the zeolitic material is included in an amount of from 0.05 wt % to 10 wt %, preferably 0.1 wt % to 5 wt %, based on the combined weight of the plastics material and the zeolitic material.

It has further been found that the zeolitic material can be recovered and reused, meaning that the process benefits are not outweighed by the addition of this further material. It can be regenerated in atmospheric air at elevated temperature allowing catalyst life to be substantially increased. Preferably the method further comprises recovering the zeolitic material from the char material, preferably by combusting the char to ash and physically separating the zeolitic material from the ash. Such a recovery is believed to be simpler where the plastics material used in the process consists essentially of plastic and is therefore substantially free of other contaminants such as metal and glass. Therefore, the process can be made more efficient and sustainable.

Methods for pyrolysis end-of-life plastics are well known in the art, including, for example, in WO2021123822, WO2016030460 and WO2011077419 which are each incorporated herein by reference. The preferred method of pyrolysis will now be described further in more detail.

Preferably the method for pyrolysis end-of-life plastics involves the steps of:
melting a waste plastics material,
pyrolysing the molten material in an oxygen-free atmosphere to provide pyrolysis gases;
bringing the pyrolysis gases into a contactor having a bank of condenser elements so that some long chain gas components condense on said elements,
returning said condensed long-chain material to be further pyrolysed to achieve thermal degradation, and allowing short chain gas components to exit from the contactor in gaseous form; and
distilling said pyrolysis gases from the contactor in a distillation column to provide one or more fuel products.

The end-of-life plastic (ELP) from the walking floor silo is discharged into the extruder hopper, which is designed to deliver heated ELP to the reactors. The extruder is supplied with variable speed drives that permit lower flow rates to be fed to the reactors, if required, during start-up and shutdown of an extruder. The extruder heats up the plastic from ambient conditions to the target set temperature using shear force generated by the rotation of the extruder screw. The high temperatures on the outlet of the extruder is required to ensure that the plastic temperature, which is lower than the reactor operating temperature, does not adversely affect the thermal performance of the reactor when loaded in.

The extruder barrel can be electrically heated, especially during start-up. During normal operation, the electric heating function is not used because the shear force from the auger screw will provide sufficient heat to melt the plastic.

Plasticised ELP is expelled from the extruder under high pressure into a melt feed line that connects the extruder to three Reactors via a header pipe. Multiple instruments monitor pressure and temperature along the melt feed line during feeding to assure flow.

The plant has multiple jacketed reactors that form the core of the process. Each conical based reactor is enclosed by a reactor jacket which provides the heat required to decompose the ELP and generate the desired hydrocarbon vapour. Each reactor is physically located above a char receiver and below a contactor (condenser elements).

Each individual reactor is provided with an agitator designed to maintain thermal efficiency of the process by minimising char build up on the walls of the reactor by maintaining close steel to steel clearance with the vessel walls; suspend any char produced during pyrolysis in the plastic mass to prevent build-up on the internal surfaces of the reactor; and homogenise the molten ELP in the reactor during processing; and remove char once pyrolysis is complete and the char is dry.

The agitator homogenises the vessel mass by pushing ELP down the walls of the reactor, to the centre of the vessel and up the agitator shaft when running in forward. When operating in reverse, it pushes medium down the agitator shaft and from the centre of the vessel to vessel walls. This promotes char removal through a bottom outlet nozzle located at the lowest point of the vessel conical dished end.

An individual reactor is designed to process 5 tonnes of ELP every day. Future generations may have a higher capacity. Reactors are grouped in threes and each trio of reactors is fed sequentially such that only one of each trio of vessels is being fed with fresh ELP at any one time whilst the other two are either completing pyrolysis or processing char.

ELP is fed into a reactor vessel by its respective Extruder. The reactor is operated at 380 to 450° C. and up to 0.5 barg in an inerted oxygen free environment. At these temperatures the ELP polymer chains decompose into shorter hydrocarbon chains and are vaporised to form a rich saturated hydrocarbon vapour. This vapour exits the vessel via an outlet located on the top of the vessel which leads to the reactors' respective contactor.

The reactor is designed to operate on a cycle. Each cycle consists of three periods. The first is a ELP feed period known as “charging” in which ELP is loaded to the reactor and pyrolysed. In the second period, pyrolysis is completed and the non-pyrolysable material (char) in the reactor is dried to allow for easy handling after removal from the reactor in anticipation of the next charge of ELP. This stage is called “cooking”. The third stage is called “removal” and involves removing char from the reactor by opening the reactor bottom outlet valve and then reversing the reactor's agitator which in turn forces char out of the reactor into the char receiver below it. Once all the char is removed the bottom outlet valve is closed and plastic feeding can recommence.

Char is formed primarily of carbonaceous material, plastic polymer-forming additives, pigmentation and ELP contamination. Char continually forms in the reactor throughout pyrolysis and must be removed prior to commencement of another charge else the effective volume of the reactor reduces. The char in the present invention further comprises the added zeolite material. The zeolite may be recovered from the char by combusting the char in air to remove the carbon material and other impurities. It has been found that the zeolite is unaffected by this combustion, even at temperature up to 550° C. Moreover, such combustion serves to further regenerate the zeolite for further use.

Char is removed through the bottom outlet nozzle and valve (BOV). When char removal is required the bottom outlet valve is opened to the char receiver below. The agitator is then set to reverse to assist char removal. Char should fall out of the chamber under gravity because of the conical shape of the reactor however if it does not, the agitator has been designed to assist it by breaking up char lumps which may have formed in the nozzle.

Preferably the contactor elements comprises a plurality of plates forming an arduous path for the pyrolysis gases in the contactor. Moreover, preferably the plates are sloped downwardly for runoff of the condensed long-chain hydrocarbon, and include apertures to allow upward progression of pyrolysis gases. In one embodiment, the contactor elements comprise arrays of plates on both sides of a gas path. Preferably the contactor element plates are of stainless steel. The contactor may be actively cooled such as by a heat exchanger for at least one contactor element.

Alternative cooling means may comprise a contactor jacket and cooling fluid is directed into the jacket. There may be a valve linking the jacket with a flue, whereby opening of the valve causing cooling by down-draught and closing of the valve causing heating. The valve may provide access to a flue for exhaust gases of a combustion unit of the pyrolysis chamber.

Preferably there is a pipe directly linking the pyrolysis chamber to the contactor, the pipe being arranged for conveying upwardly-moving pyrolysis gases and downwardly-flowing long-chain liquid for thermal degradation.

Preferably infeed to the pyrolysis chamber is controlled according to monitoring of level of molten plastics in the chamber, as detected by a gamma radiation detector arranged to emit gamma radiation through the chamber and detect the radiation on an opposed side, intensity of received radiation indicating the density of contents of the chamber.

Preferably the pyrolysis chamber is agitated by rotation of at least two helical blades arranged to rotate close to an internal surface of the pyrolysis chamber. Optionally, the pyrolysis chamber is further agitated by a central auger. Advantageously, the auger can be located so that reverse operation of it causes output of char via a char outlet.

Preferably the temperature of pyrolysis gases at an outlet of the contactor is maintained in the range of 240° C. to 280° C. The contactor outlet temperature can be maintained by a heat exchanger at a contactor outlet.

A bottom section of the distillation column is preferably maintained at a temperature in the range of 200° C. to 240° C., preferably 210° C. to 230° C. The top of the distillation column is preferably maintained at a temperature in the range of 90° C. to 110° C., preferably approximately 100° C.

Optionally there is further distillation of some material in a vacuum distillation column. Heavy or waxy oil fractions are drawn from the bottom of the vacuum distillation column and can be recycled back to the pyrolysis chamber. Desired grade on-specification pyrolysis oil can be drawn from a middle section of the vacuum distillation column. Light fractions are drawn from a top section of the vacuum distillation column and are condensed.

The inventors have found unexpected advantages when the zeolitic material comprises a zeolite having particular parameters, specifically a molar silica to alumina ratio (SAR) of from 10 to 140, a mean crystal size of about 200 nm or less, a mesopore volume of at least 0.30 cm3/g and a micropore volume of at least 0.10 cm3/g.

In particular, the inventors have found an unexpected benefit where the zeolite has such a small crystal size and is desilicated and therefore preferably has a low SAR, such as from 10 to 100, preferably 10 to 50. Even more preferably the zeolitic material has a SAR of at least 15 and/or at most 30, preferably at most 25. These ranges are particularly optimised for waste mixed plastic, i.e. that obtained from municipal recovery facilities, recycling factories, or other plastic collection sources and are particularly advantageous for the purpose of reducing residue and enhancing the pyrolysis efficiency of plastic waste. For example, the plastic may consist essentially of a mixture of low density polyethylene, high density polyethylene, polypropylene and/or polystyrene, and optionally other plastics such as polyvinylchloride, polyethylene terephthalate and/or polycarbonate (preferably as a minority when present). Preferably the zeolitic material a mean crystal size of about 100 nm or less, preferably about 50 nm or less. Crystal sizes can be determined by a number of different techniques, including laser diffraction or sieving or by SEM as described herein.

Preferably the zeolitic material has a mesopore volume of at least 0.40 cm³/g, more preferably at least 0.50 cm³/g, and/or at most 0.90 cm3/g. Preferably the zeolitic material has a micropore volume of at most 0.40 cm³/g, preferably at most 0.20 cm3/g.

Such parameters providing a unique combination of zeolitic features which have been found to enhance the process of plastic pyrolysis may be achieved by using a desilicated zeolite, such as one obtainable by a process comprising:
mixing a parent zeolite having a mean crystal size of 200 nm or less in a base solution to form a desilication slurry;
collecting the solids by filtration or other separation methods;
drying; and
optionally calcining the solids;
wherein the parent zeolite is mixed in a base solution with from 1 to 20 mmol of base per gram of anhydrous parent zeolite at a temperature range from 0° C. to 100° C. for a period of time sufficient to create a mesopore volume of 0.40 cm³/g or more; and
wherein the solid content defined as the percentage weight of the anhydrous parent zeolite to the total weight of the desilication slurry ranges from 1 to 40 wt %. The total time of desilication can be in the range of 0.5 to 24 hours.

Desilication can be done with a suitable base, such as sodium hydroxide or potassium hydroxide. The mixture of zeolite and a base solution is defined as the desilication suspension or desilication slurry. Optionally, quaternary ammonium compounds in the salt or hydroxide form can be added to the desilication slurry. Preferably the base is chosen from LiOH, NaOH, KOH, NH4OH, and tetraalkylammonium hydroxide. Preferably the zeolitic material obtained by the process in which the zeolitic material has a ΔV/silica loss ratio of at least 0.8.

At least one quaternary ammonium compound in a salt or hydroxide form can optionally be added to the desilication slurry in the range of 0.1 to 10 mmol/g of quaternary ammonium compounds per gram of anhydrous zeolite. The desilicated form of the zeolite can be subjected to ion-exchange in order to remove the alkali cations from the zeolite. Ion exchange is typically done using ammonium salts, such as ammonium nitrate or ammonium chloride.

In another process for obtaining the zeolite for use in the plastic pyrolysis method of the present invention, acid, such as nitric acid or hydrochloric acid, can be used in addition to any ammonium salt during the ion-exchange to facilitate dealumination of the desilicated mesoporous zeolite. Ion-exchange is preferably conducted using 1 to 50 mmol of ammonium salt and 1 to 20 mmol of acid per gram of anhydrous zeolite. The temperature of the ion-exchange process can be in the range from 20° C. to 100° C. The total time of ion-exchange can be in the range of 0.5 to 24 hours. The ion-exchange can be repeated to achieve the desired residual amount of alkali in the zeolite.

The inventors have found that by using a low SAR, small crystal zeolite, a significant improvement in the total conversion of plastics to distillate (pyrolysis oil) and gases (i.e. syngas) is achieved. More particularly, the inventors were surprised to find that, compared to simply desilicated low SAR zeolite and small crystal size zeolite, the increase in the total conversion is more heavily directed to conversion of the more useful pyrolysis oil thereby providing an enhanced ratio of distillate to syngas. As such, the particular combination of mesopore and micropore volume and in particular SAR and mean crystal size provide an unexpected synergy which is advantageous for plastic pyrolysis applications.

As such, it is preferred that the yield of char material is less than 20 wt %, preferably less than 10 wt %, in the present method. It is also preferred that the yield of pyrolysis oil is at least 40 wt %, preferably at least 50 wt %. Thus, in a particularly preferred embodiment, the ratio by weight of pyrolysis oil to the pyrolysis gases remaining after condensing the pyrolysis oil from the pyrolysis gases is at least 1.2:1.

In another aspect, the present invention relates to the use of the desilicated zeolitic material to increase ratio by weight of pyrolysis oil to the pyrolysis gases remaining after condensing the pyrolysis oil from the pyrolysis gases relative to a conventional zeolite.

### EXAMPLES

The following non-limiting examples, which are intended to be exemplary, further clarify the present disclosure.

### Sample 1

50 grams of the 51 SAR ZSM-5 zeolite in calcined OSDA-free form with a mean SEM crystal size of 50 nm shown in Table 1 was added to 238 grams of DI water and mixed at room temperature. 29 grams of 50 wt % sodium hydroxide solution was added to the zeolite suspension in water and the resulting mixture was stirred at room temperature for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Sample 2

50 grams of the same starting material as in Sample 1 was added to 229 grams of DI water and mixed at room temperature. 38 grams of 50 wt % sodium hydroxide solution was added to the zeolite suspension in water and the resulting mixture was stirred at room temperature for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Sample 3

50 grams of the same starting material as in Sample 1 was added to 257 grams of DI water and heated to 40° C. 9.5 grams of 50 wt % sodium hydroxide solution was added to the zeolite suspension in water and the resulting mixture was stirred at 40° C. for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Sample 4

50 grams of the same starting material as in Sample 1 was added to 248 grams of DI water and heated to 60° C. 19 grams of 50 wt % sodium hydroxide solution was added to the zeolite suspension in water and the resulting mixture was stirred at 60° C. for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Sample 5

100 grams of the 30 SAR ZSM-5 zeolite in as-synthesized OSDA-containing form with a mean crystal size of 40 nm shown in Table 1 was added to 421 grams of DI water mixed at room temperature. 71 grams of 50 wt % sodium hydroxide solution was added to the zeolite suspension in water and the resulting mixture was stirred at room temperature for 2 hours. Then, the desilicated zeolite was filtered and washed with DI water.

Acidified ammonium exchange of the desilicated zeolite was done using one contact with a mixture of nitric acid and ammonium nitrate solution (0.6:2.5:1 nitric acid:ammonium nitrate:zeolite weight ratio) and one contact with ammonium nitrate solution (2.5 ammonium nitrate to zeolite weight ratio) at 80° C. for 2 hours. After each contact, the zeolite was filtered and washed with DI water. The ion exchanged sample was dried in air at 105° C. The ion-exchanged sample exhibited the properties summarized in Table 1.

### Comparative Sample 1

Comparative CBV 5524G zeolite, a commercial zeolite produced by Zeolyst International, having a mean crystal size of 230 nm shown in Table 1 was processed under the same conditions as the ZSM-5 in Sample 1. 50 grams of the comparative ZSM-5 zeolite was added to 232 grams of DI water and mixed at room temperature. 28 grams of 50 wt % sodium hydroxide solution was added to the zeolite suspension in water and the resulting mixture was stirred at room temperature for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Comparative Sample 2

Comparative CBV 5524G zeolite, a commercial zeolite produced by Zeolyst International, was processed under the same conditions as the ZSM-5 in Sample 2. 50 grams of the comparative ZSM-5 zeolite was added to 223 grams of DI water and mixed at room temperature. 37 grams of 50 wt % sodium hydroxide solution was added to the zeolite suspension in water and the resulting mixture was stirred at room temperature for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Comparative Sample 3

Comparative CBV 5524G zeolite, a commercial zeolite produced by Zeolyst International, was processed under the same conditions as the ZSM-5 in Sample 3. 50 grams of the comparative ZSM-5 zeolite was added to 251 grams of DI water and heated to 40° C. 9.3 grams of 50 wt % sodium hydroxide solution was added to the zeolite suspension in water and the resulting mixture was stirred at 40° C. for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Comparative Sample 4

Comparative CBV5524G zeolite, a commercial zeolite produced by Zeolyst International, was processed under the same conditions as the ZSM-5 in Sample 4. 50 grams of the comparative ZSM-5 zeolite was added to 241 grams of DI water and heated to 60° C. 19 grams of 50 wt % sodium hydroxide solution was added to the zeolite suspension in water and the resulting mixture was stirred at 60° C. for 2 hours. Then, the desilicated zeolite was filtered and washed with DI water.

Ammonium exchange of the desilicated zeolite was done using two contacts with ammonium nitrate solution (2.5 ammonium nitrate to zeolite weight ratio) at 80° C. for 2 hours. After each contact, the zeolite was filtered and washed with DI water. The ammonium-exchanged sample was dried in air at 105° C. The ammonium-exchanged sample exhibited the properties summarized in Table 1.

### Comparative Sample 5

Comparative 25 SAR ZSM-5, a commercial CBV 2314 zeolite produced by Zeolyst International, was processed under the same conditions as the ZSM-5 in Sample 5. 100 grams of the comparative zeolite was added to 421 grams of DI water mixed at room temperature. 71 grams of 50 wt % sodium hydroxide solution was added to the zeolite suspension in water and the resulting mixture was stirred at room temperature for 2 hours. Then, the desilicated zeolite was filtered and washed with DI water.

Acidified ammonium exchange of the desilicated zeolite was done using one contact with a mixture of nitric acid and ammonium nitrate solution (0.6:2.5:1 nitric acid:ammonium nitrate:zeolite weight ratio) and one contact with ammonium nitrate solution (2.5 ammonium nitrate to zeolite weight ratio) at 80° C. for 2 hours. After each contact, the zeolite was filtered and washed with DI water. The ion exchanged sample was dried in air at 105° C. The ion-exchanged sample exhibited the properties summarized in Table 1.

TABLE 1
Analytical data for parent materials and the materials
prepared in the processes described above.

| | Mean SEM | | | | Silica | | | | ΔV/ |
|---|---|---|---|---|---|---|---|---|---|
| | crystal | NaOH:Zeolite | | | Loss | V_{micro} | Vₘₑₛₒ | ΔV | silica |
| Sample | size, nm | mmol:g | T ° C. | SAR | wt % | cc/g | cc/g | cc/g | loss |
| Small-crystal | 50 | — | — | 51 | — | 0.14 | 0.26 | — | — |
| Small-crystal | 40 | — | — | 32 | — | 0.11 | 0.47 | — | — |
| CBV 5524G | 230 | — | — | 62 | — | 0.14 | 0.11 | — | — |
| CBV 2314 | 290 | — | — | 24 | — | 0.15 | 0.04 | — | — |
| Sample 1 | 50 | 7.5 | 20 | 44 | 14% | 0.13 | 0.53 | 0.27 | 1.9 |
| Sample 2 | 50 | 10.0 | 20 | 43 | 16% | 0.13 | 0.53 | 0.27 | 1.7 |
| Sample 3 | 50 | 2.5 | 40 | 44 | 13% | 0.13 | 0.39 | 0.13 | 1.0 |
| Sample 4 | 50 | 5.0 | 60 | 34 | 34% | 0.12 | 0.56 | 0.30 | 0.9 |
| Sample 5 | 40 | 10.0 | 20 | 36 | 12% | 0.13 | 0.80 | 0.33 | 2.8 |
| Comp. | 230 | 7.5 | 20 | 55 | 12% | 0.11 | 0.18 | 0.07 | 0.6 |
| Sample 1 | | | | | | | | | |
| Comp. | 230 | 10.0 | 20 | 55 | 11% | 0.13 | 0.21 | 0.10 | 0.9 |
| Sample 2 | | | | | | | | | |
| Comp. | 230 | 2.5 | 40 | 55 | 11% | 0.12 | 0.17 | 0.06 | 0.5 |
| Sample 3 | | | | | | | | | |
| Comp. | 230 | 5.0 | 60 | 44 | 28% | 0.12 | 0.29 | 0.18 | 0.6 |
| Sample 4 | | | | | | | | | |
| Comp. | 290 | 10.0 | 20 | 23 | 5% | 0.14 | 0.08 | 0.04 | 0.8 |
| Sample 5 | | | | | | | | | |

### Example 1

Three zeolites were tested in a pilot plant for plastic pyrolysis under identical operating conditions (350° C., 2 hours, 1 barg):
1. A desilicated zeolite ZSM-5 produced by post synthesis modification of a commercial zeolite ZSM 5 (SAR=22.4 and mean crystal size≈200 nm)
2. A nano size zeolite ZSM-5 (SAR=27.2 and mean crystal size≈50 nm)
3. A nano size zeolite ZSM-5 desilicated (SAR=19.5 and mean crystal size≈50 nm)

The results of pyrolysis reaction with these 3 catalysts are shown below (Table 2).

TABLE 2
ZSM-5 zeolite performance comparison.

| | ZSM-5 | | Nano size ZSM-5 |
|---|---|---|---|
| Yield (%) | desilicated | Nano size ZSM-5 | desilicated |
| Distillate | 37.7 | 45.7 | 51.8 |
| (pyrolysis oil) | | | |
| Residue (char) | 29.8 | 13.3 | 5.4 |
| Gases (syngas) | 32.5 | 40.9 | 42.8 |
| Conversion | 70.2 | 86.7 | 94.6 |
| Ratio of distillate | 1.16 | 1.12 | 1.21 |
| to gases | | | |

These results demonstrate that the nano size ZSM 5 zeolite is more active than desilicated ZSM 5 zeolite: 86.7% vs 70.2% conversion, respectively. However, the desilicated ZSM 5 is more selective to distillate than the nano size zeolite: 1.16 vs 1.12 distillate to syngas ratio, respectively.

The nano size ZSM-5 desilicated is the best zeolite of the three described above as it shows a conversion of 94.6% vs. 86.7 and 70.2% and a ratio of distillate to syngas of 1.21 vs. 1.16 and 1.12.

These results clearly show the superior advantage of using desilicated nano size zeolite for improving ZSM-5 zeolite activity to ELP pyrolysis and selectivity to distillate.

As used herein, the singular form of “a”, “an” and “the” include plural references unless the context clearly dictates otherwise. The use of the term “comprising” is intended to be interpreted as including such features but not excluding other features and is also intended to include the option of the features necessarily being limited to those described. In other words, the term also includes the limitations of “consisting essentially of” (intended to mean that specific further components can be present provided they do not materially affect the essential characteristic of the described feature) and “consisting of” (intended to mean that no other feature may be included such that if the components were expressed as percentages by their proportions, these would add up to 100%, whilst accounting for any unavoidable impurities), unless the context clearly dictates otherwise.

The foregoing detailed description has been provided by way of explanation and illustration, and is not intended to limit the scope of the appended claims. Many variations of the presently preferred embodiments illustrated herein will be apparent to one of ordinary skill in the art, and remain within the scope of the appended claims and their equivalents.

I/We claim:

1. A method for the production of a pyrolysis oil from end-of-life plastics, the method comprising:
(i) providing end-of-life plastics material;
(ii) melting the end-of-life plastics material to form a molten plastics material;
(iii) pyrolysing the molten plastics material in an oxygen-free atmosphere to provide pyrolysis gases and a char material; and
(iv) condensing the pyrolysis gases to provide the pyrolysis oil;
wherein the method further comprises dispersing a zeolitic material in the end-of-life plastics material or in the molten plastics material, characterised in that the zeolitic material comprises a zeolite having a molar silica to alumina ratio (SAR) of from 10 to 140, a mean crystal size of about 200 nm or less, and wherein the zeolitic material has a mesopore volume of at least 0.30 cm3/g and a micropore volume of at least 0.10 cm3/g.

2. The method according to claim 1, wherein the zeolitic material comprises a medium pore zeolite, preferably having MFI framework type, more preferably ZSM-5.

3. The method according to claim 1, wherein the zeolitic material has a SAR of at least 15 and/or at most 30.

4. The method according to claim 1, wherein the zeolitic material is included in an amount of from 0.05 wt % to 10 wt %, based on the combined weight of the plastics material and the zeolitic material.

5. The method according to claim 1, wherein the zeolitic material comprises a mean crystal size of about 100 nm or less, preferably about 50 nm or less.

6. The method according to claim 1, wherein the zeolitic material has a mesopore volume of at least 0.40 cm3/g and/or at most 0.90 cm3/g.

7. The method according to claim 1, wherein the zeolitic material is in H exchanged form.

8. The method according to claim 1, wherein the zeolitic material has a micropore volume of at most 0.40 cm3/g.

9. The method according to claim 1, further comprising recovering the zeolitic material from the char material by combusting the char to ash and physically separating the zeolitic material from the ash.

10. The method according to claim 1, wherein the end-of-life plastics material is melted in step (ii) in a heated extruder at a temperature of from 250 to 350° C.

11. The method according to claim 1, wherein the pyrolysis of step (iii) is conducted in an agitated pyrolysis reactor at a temperature of from 350 to 450° C.

12. The method according to claim 1, wherein, before step (iv), the method further comprises:
passing the pyrolysis gases from step (iii) into a contactor having a bank of condenser elements so that some long chain gas components condense on said elements to provide a condensed long chain material;
returning the condensed long chain material to step (iii) to be further pyrolysed; and
allowing short chain gas components to exit from the contactor in gaseous form before condensing in step (iv).

13. The method according to claim 1, wherein step (iv) comprises distilling the pyrolysis gases from the contactor in a distillation column.

14. The method according to claim 1, wherein the zeolitic material is obtained by a process comprising:
mixing a parent zeolite having a mean crystal size of 200 nm or less in a base solution to form a desilication slurry;
collecting solids from the slurry;
drying the collected solids; and
calcining the solids;
wherein the parent zeolite is mixed in a base solution with from 1 to 20 mmol of base per gram of anhydrous parent zeolite at a temperature range from 0° C. to 100° C. for a period of time sufficient to create a mesopore volume of 0.40 cm³/g or more; and
wherein the solid content defined as the percentage weight of the anhydrous parent zeolite to the total weight of the desilication slurry ranges from 1 to 40 wt %.

15. The method according to claim 14, wherein the base is chosen from LiOH, NaOH, KOH, NH₄OH, and tetraalkylammonium hydroxide.

16. The method according to claim 14, wherein the zeolitic material obtained by the process in which the zeolitic material has a ΔV/silica loss ratio of at least 0.8.

17. The method according to claim 1, wherein the yield of char material is less than 20 wt %, preferably less than 10 wt %.

18. The method according to claim 1, wherein the yield of pyrolysis oil is at least 40 wt %, preferably at least 50 wt %.

19. The method according to claim 1, wherein the ratio by weight of pyrolysis oil to the pyrolysis gases remaining after condensing the pyrolysis oil from the pyrolysis gases is at least 1.2:1.

20. A method for the production of a pyrolysis oil from end-of-life plastics, the method comprising:
providing end-of-life plastics material;
melting the end-of-life plastics material to form a molten plastics material;
pyrolysing the molten plastics material in an oxygen-free atmosphere to provide pyrolysis gases and a char material;
condensing the pyrolysis gases to provide the pyrolysis oil; and
dispersing a zeolitic material in the end-of-life plastics material and/or in the molten plastics material, wherein—
the zeolitic material comprises a zeolite having a molar silica to alumina ratio (SAR) of from 10 to 140, and a mean crystal size of about 200 nm or less, and
the zeolitic material has a mesopore volume of at least 0.30 cm3/g and a micropore volume of at least 0.10 cm3/g.
